(19) United States
(12) Patent Application Publication
(10) Pub. No.: US 2013/0236847 A1
(43) Pub. Date: Sep. 12, 2013

(54) SELF-LIGATION ORTHODONTIC BRACKET

(71) Applicant: Woo Seok Shin, Gyeonggi-do (KR)

(72) Inventor: Woo Seok Shin, Gyeonggi-do (KR)

(73) Assignee: HUBIT CO., LTD., Gyeonggi-do (KR)

(21) Appl. No.: 13/885,729

(22) PCT Filed: May 18, 2011
(86) PCT No.: PCT/KR11/03671

§ 371 Date: May 16, 2013

(30) Foreign Application Priority Data
Nov. 18, 2010 (KR) 10-2010-0115073
Jan. 20, 2011 (KR) 10-2011-0005792

(51) Int. Cl. A61C 7/30; A61C 7/02

(52) U.S. Cl. CPC A61C 7/30; A61C 7/023
USPC 433/3; 433/9

(57) ABSTRACT

The present invention relates to a self-ligation bracket for correcting teeth alignment comprising: on one side a body 210 further comprising a connection part 2110 and an attachable portion 2120, the connection part being provided on the upper portion of an insertion groove 2111 and an insertion groove 2111 having a predetermined depth into which an archwire is inserted, being provided on the lower portion of the insertion groove and a plurality of fixing protrusions provided with fixing grooves on one side, and being provided in between a supporting protrusion 2114 and a supporting protrusion 2114 which are arranged with a predetermined distance apart from each other, and the body 210 formed with a hooking space 2118 which is provided on the downside of a guide protrusion 2116 that protrudes to a predetermined height and the insertion groove 2111; and a cap spring 220 provided with an elastic fixing part 222 on one side, an elastic hanging part 224 on the other side, and a bent portion 223 which is at the end portion of the elastic fixing part 222 and bent outward at a predetermined angle, wherein the bent portion 223 of the elastic fixing part 222 is inserted into a fixing groove 2113 and the elastic hanging part 224 is inserted into the hooking space of the body 210 so as to couple to the body 210. The present invention minimizes the number of parts thereby lowering the manufacturing cost of the product, reduces the working procedure thereby lowering the overall cost of the product, and minimizes the amount of food which becomes caught thereby preventing teeth damage and discoloration of the bracket to enhance the competitiveness of the product.

### BACKGROUND

1. Field of the Invention

The present invention relates to a self-ligation orthodontic bracket, and more particularly, to a self-ligation orthodontic bracket in which the number of components is minimized, manufacturing cost is reduced, the number of working processes is reduced so that the whole product price can be lowered, and a phenomenon that food gets stuck is minimized so that an injury of the teeth and discoloration of the bracket can be prevented and product competitiveness can be strengthened.

2. Discussion of Related Art

In general, a state in which the teeth are crooked and a set of teeth is not even is referred to as “malocclusion” in dental medicine terms, and treatment for correcting malocclusion is referred to as remedial treatment.

When the teeth or a set of teeth is in the state of malocclusion, there are many obstacles that the appearance is ugly distorted, it is difficult to chew, wind goes through the teeth and pronunciation becomes unclear.

Thus, a variety of orthodontic methods for correcting irregularities have been developed and used so as to remove the obstacles.

There is an orthodontic method using a bracket among various orthodontic methods according to the related art.

Referring to FIG. 1, an orthodontic apparatus that is used in the orthodontic method using a bracket according to the related art includes a bracket 10 that are formed on wings 11 and constitute an insertion groove 12 configured of an inclination surface 13 with a radiation angle of 15° to 25° so that vertical insertion wires, an archwire 20, a binder 30, and a wedge 40 can be additionally used, the archwire 20 inserted into the insertion groove 12 of the bracket 10, the binder 30 inserted into the insertion groove 12 so as to fix the archwire 20, and the wedge 40.

However, in such a bracket according to the related art, an additional connection wire is required to fix a plurality of brackets and an archwire to each other, and a portion that protrudes to the outside of the bracket after the connection wire is installed, is not smooth.

Also, it is inconvenient to perform a connection work using the connection wire so as to fix the archwire to the brackets, and it takes a long time to do a connection work.

Also, since the connection wire is a steel wire, the lips or the inner cheek may get stabbed, or the connection wire may come loose.

As a way to solve the problems, Korean Patent Prior Registration No. 959151 filed by the present applicant entitled by Self-ligation Orthodontic Apparatus has been suggested, as illustrated in FIG. 2.

Referring to FIG. 2, a self-ligation orthodontic apparatus includes a bracket 110 that includes a head part 111, of which a bottom surface is attached to the teeth and which protrudes from one side of a top surface, a binding-piece mounting groove 113 formed in a side of the head part 111 in a horizontal direction, an archwire mounting groove 114 formed in a lower side of the binding-piece mounting groove 113, and an elastic fixing plate insertion hole 117 that is perforated into a lower side of the archwire mounting groove 114 to cross the archwire mounting groove 114, an elastic fixing plate 120 that is inserted into the elastic fixing plate insertion hole 117, has a hanging side 122 formed at an end thereof and a cap spring fixing part 121 formed so that a cap spring 130 can be fixed to an end of a curved part 123 curved upward and that is formed of an elastic body, and the cap spring 130 that is fixed to the elastic fixing plate 120.

Thus, when an archwire is inserted into the archwire mounting groove 114 of the bracket 110 and then the elastic fixing plate 120 and the cap spring 130 are coupled to the bracket 110, working conveniences in which the archwire is fixed, are improved.

However, the above Prior Registration Patent filed by the present applicant has the following problems.

1. Manufacturing cost is high.

Since the orthodontic apparatus includes the bracket 110, the elastic fixing plate 120, and the cap spring 130, they should be individually manufactured so that manufacturing cost increases, and they should be individually assembled so that a working time increases.

Also, due to the above problems, the whole product price increases so that product competitiveness is deteriorated.

2. Food gets stuck.

Since the orthodontic apparatus includes a plurality of components, food gets stuck between coupling gaps between the components.

Also, when food got stuck in the orthodontic apparatus is left for a long time, spoilage occurs and causes a chemical reaction with the teeth and thus the teeth may be hurt.

Also, as the orthodontic apparatus is discolored due to food spoilage, a user repulses the discolored orthodontic apparatus.

3. The lips or an inside of the mouth may be hurt by the orthodontic apparatus.

Since the sizes of borders of the bracket, the elastic fixing plate, and the cap spring are the same, the lips or the tongue may be scratched by the orthodontic apparatus due to a chewing action or other actions.

4. The cap spring coupled to the bracket cannot be separated from the bracket.

The cap spring should be destroyed so as to separate the cap spring from the bracket after an orthodontic operation is completed.

### SUMMARY OF THE INVENTION

The present invention is directed to providing a self-ligation orthodontic bracket in which the number of components is minimized, manufacturing cost is reduced, the number of working processes is reduced so that the whole product price can be lowered, and a phenomenon that food gets stuck is minimized so that an injury of the teeth and discoloration of the bracket can be prevented and product competitiveness can be strengthened.

One aspect of the present invention provides a self-ligation orthodontic bracket including: a body including a connection part that is formed at one side of the body and allows an archwire to be inserted and to be supported and an attachable portion that is formed at the other side of the body and is adhered to teeth wherein the connection part includes an insertion groove formed in a horizontal direction based on an installation state of the bracket and having a predetermined depth at which the archwire is inserted into the insertion groove, a plurality of fixing protrusions formed at an upper part of the insertion groove and having a fixing groove formed in one side of each of the plurality of fixing protrusions, a plurality of supporting protrusions formed at a lower part of the insertion groove and spaced apart from each other by a predetermined distance, guide protrusions formed between the plurality of supporting protrusions and protruding to a predetermined height, and a hooking space that is formed in a downward direction of the insertion groove and is penetrated in a direction in which a center of the body crosses the insertion groove; and a cap spring including an elastic fixing part that is formed at one side of the cap spring and an elastic hanging part that is formed at the other side of the cap spring, wherein a bent portion is formed at an end of the elastic fixing part and is bent to an outer side of the elastic fixing part at a predetermined angle, when both ends of the elastic fixing part are supported and enter between the supporting protrusions of the body, the elastic fixing part is guided to outer surfaces of the guide protrusions, the bent portion of the elastic fixing part is inserted into the fixing groove, and the elastic hanging part is inserted into the hooking space of the body and is ligated to the body.

The body may further include a hanging groove formed in one side of the hooking space and having a predetermined depth, and the cap spring may further include a hanging protrusion formed at one side of the elastic hanging part and having a predetermined height at which the hanging protrusion is inserted into the hanging groove of the body when the elastic hanging part is ligated to the body.

A tool insertion hole may be formed in one side of the elastic fixing part of the cap spring and may allow part of a tool used when the cap spring is detached from the body to be inserted into the tool insertion hole and may allow the cap spring to be easily detached from the body.

An accommodation space that is recessed to a predetermined depth so that a predetermined amount of an adhesive is accommodated in the accommodation space when the adhesive is applied to the attachable portion, may be formed in the attachable portion of the body, a center part may be formed in the accommodation space, and peripheral parts having a larger depth than the center part may be formed on a periphery of the center part.

A plurality of protrusions may be formed in the accommodation space, and as the plurality of protrusions have heights that are the same as or slightly less than a surface of the attachable portion and no adhesive accommodated in the accommodation space is applied to the attachable portion, the plurality of protrusions may allow the body to be easily detached from the teeth as air permeates into portions where no adhesive is applied, when a tool is shaken so as to remove the body from the teeth after an orthodontic operation is completed.

The accommodation space may be divided into three parts, that is, a center part and peripheral parts formed at both sides of the center part based on the body adhered to the teeth.

Another aspect of the present invention provides a self-ligation orthodontic bracket including: a body including a connection part that is formed at one side of the body and allows an archwire to be inserted and to be supported and an attachable portion that is formed at the other side of the body and is adhered to teeth, wherein the connection part includes an insertion groove formed in a horizontal direction based on an installation state of the bracket and having a predetermined depth at which the archwire is inserted into the insertion groove, a plurality of fixing protrusions formed at an upper part of the insertion groove and having a fixing groove formed in one side of each of the plurality of fixing protrusions, hanging protrusion parts that protrude between the plurality of fixing protrusions and are formed close to the fixing protrusions so that the center of the body passes through the hanging protrusion parts, a plurality of supporting protrusions formed at a lower part of the insertion groove and spaced apart from each other by a predetermined distance, guide protrusions formed between the plurality of supporting protrusions and protruding to a predetermined height, and a hooking space that is formed in a downward direction of the insertion groove and is penetrated in a direction in which a center of the body crosses the insertion groove; and a cap spring including an elastic fixing part that is formed at one side of the cap spring and an elastic hanging part that is formed at the other side of the cap spring, wherein a bent portion is formed at an end of the elastic fixing part and is bent to an outer side of the elastic fixing part at a predetermined angle, a fitting groove is formed through one side of the elastic fixing part, when both ends of the elastic fixing part are supported and enter between the supporting protrusions of the body, the elastic fixing part is guided to outer surfaces of the guide protrusions, the bent portion of the elastic fixing part is inserted into the fixing groove, the elastic hanging part is inserted into the hooking space of the body and is ligated to the body, and both ends of the fitting groove are fitted to and fixed to the hanging protrusion parts.

The body may further include a hanging groove formed in one side of the hooking space and having a predetermined depth, and the cap spring may further include a hanging protrusion formed at one side of the elastic hanging part and having a predetermined height at which the hanging protrusion is inserted into the hanging groove of the body when the elastic hanging part is ligated to the body.

A tool insertion hole may be formed in a side of the fitting groove of the cap spring and may allow part of a tool used when the cap spring is detached from the body to be inserted into the tool insertion hole and may allow the cap spring to be easily detached from the body.

An accommodation space that is recessed to a predetermined depth so that a predetermined amount of an adhesive is accommodated in the accommodation space when the adhesive is applied to the attachable portion, may be formed in the attachable portion of the body, and a center part may be formed in the accommodation space, and peripheral parts having a larger depth than the center part may be formed on a periphery of the center part.

A plurality of protrusions may be formed in the accommodation space, and as the plurality of protrusions have heights that are the same as or slightly less than a surface of the attachable portion and no adhesive accommodated in the accommodation space is applied to the attachable portion, the plurality of protrusions may allow the body to be easily detached from the teeth as air permeates into portions where no adhesive is applied, when a tool is shaken so as to remove the body from the teeth after an orthodontic operation is completed.

The accommodation space may be divided into three parts, that is, a center part and peripheral parts formed at both sides of the center part based on the body adhered to the teeth.

### BRIEF DESCRIPTION OF THE DRAWINGS

The above and other objects, features and advantages of the present invention will become more apparent to those of ordinary skill in the art by describing in detail example embodiments thereof with reference to the attached drawings, in which:

FIG. 1 is an exploded perspective view of a bracket according to the related art.

FIG. 2 is an exploded perspective view of another bracket according to the related art.

FIG. 3 is an exploded perspective view of a bracket according to an embodiment of the present invention.

FIG. 4 is a bottom view of a body according to an embodiment of the present invention.

FIG. 5 is a cross-sectional view illustrating a state in which the body is attached to the teeth, according to an embodiment of the present invention.

FIGS. 6A through 6E are views illustrating a state in which the body and a cap spring are coupled to each other or are detached from each other, according to an embodiment of the present invention.

FIG. 7 is a view illustrating a state in which the cap spring is detached from the body, according to an embodiment of the present invention.

FIG. 8 is a view illustrating a state in which the body is detached from the teeth, according to an embodiment of the present invention.

FIG. 9 is an exploded perspective view of a bracket according to another embodiment of the present invention.

FIG. 10 is a plan view illustrating a state in which a cap spring is coupled to a body, according to another embodiment of the present invention.

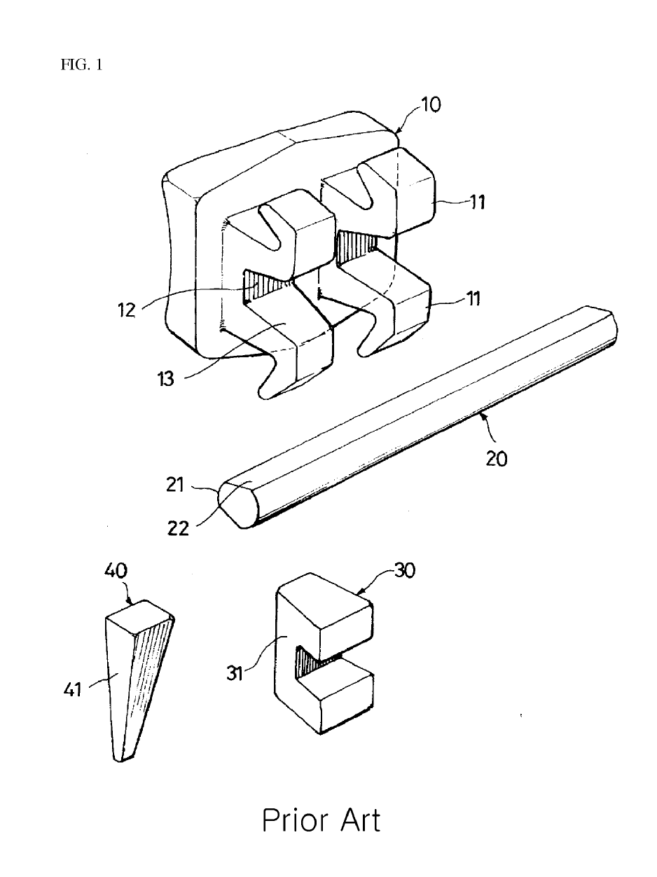

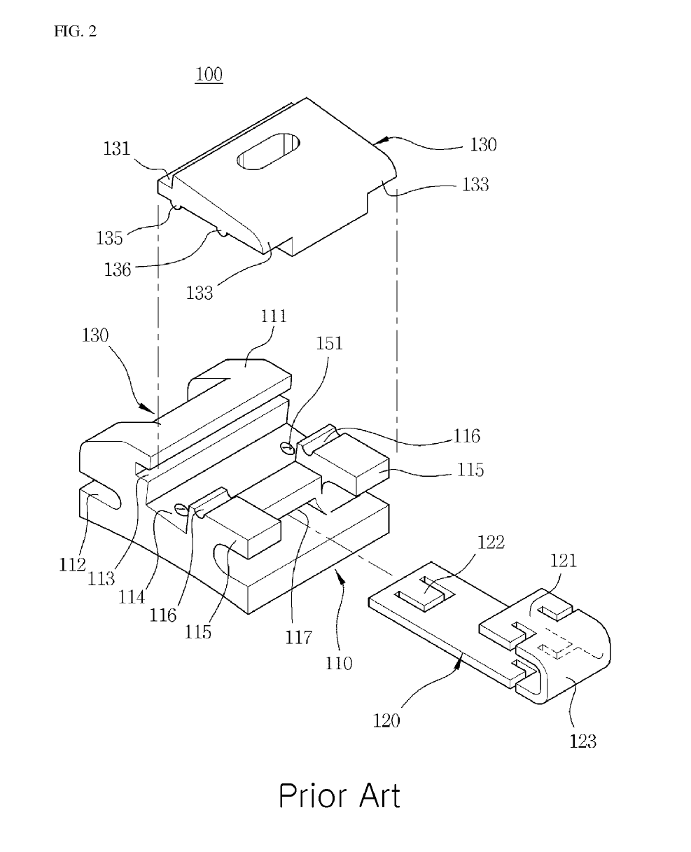

### DETAILED DESCRIPTION OF EXAMPLE EMBODIMENTS

### First Embodiment

Hereinafter, an exemplary embodiment of the present invention will be described in detail.

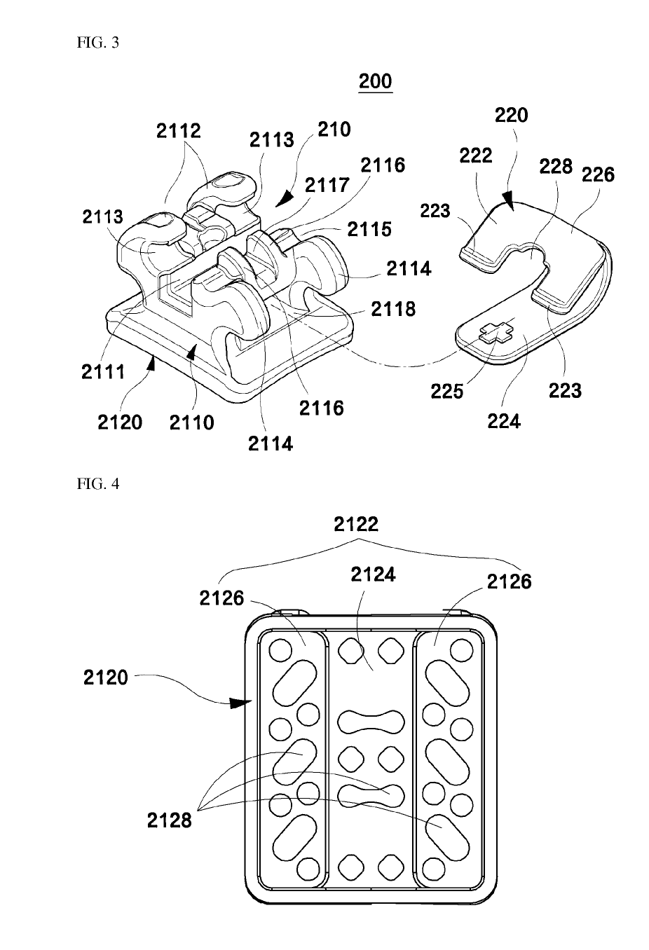

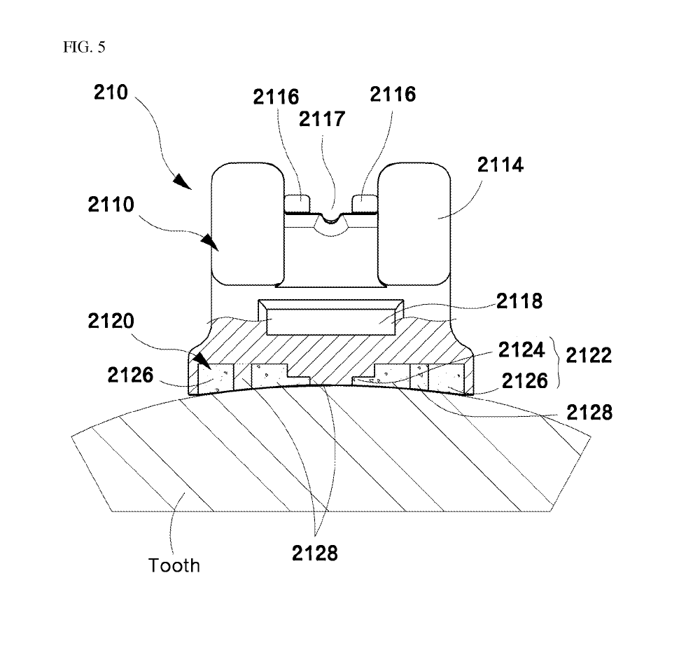

FIG. 3 is an exploded perspective view of a bracket according to an embodiment of the present invention, FIG. 4 is a bottom view of a body according to an embodiment of the present invention, and FIG. 5 is a cross-sectional view illustrating a state in which the body is attached to the teeth, according to an embodiment of the present invention. The following descriptions will be provided with reference to the above drawings.

A bracket 200 according to the present invention includes a body 210 and a cap spring 220.

The body 210 includes a connection part 2110 that is formed at one side of the body 210, has an insertion groove 2111 into which an archwire 20 is inserted and allows the archwire 20 to be fixed due to the cap spring 220 ligated to the body 210, and an attachable portion 2120 that is formed at the other side of the body 210 and is adhered to and fixed to the surface of the teeth.

The connection part 2110 and the attachable portion 2120 of the body 210 are formed integrally with each other. Since the size of a border of the connection part 2110 is relatively smaller than the size of the attachment 2120, an injury of the lips or an inside of the mouth may be minimized.

The insertion groove 2111 is formed in the connection part 2110 of the body 210, crosses the center of the body 210 in a horizontal direction based on the installation state of the body 210, and has a predetermined depth at which the archwire 20 is inserted into the insertion groove 2111.

The connection part 2110 includes a plurality of fixing protrusions 2112 formed at an upper part of the insertion groove 2111 and a plurality of supporting protrusions 2114 formed at a lower part of the insertion groove 2111.

A fixing groove 2113 having a predetermined depth is formed in each of the fixing protrusions 2112, and one end of the cap spring 220 is inserted into the fixing groove 2113.

Each of the supporting protrusions 2114 is a unit that supports the cap spring 220 when one end of the cap spring 220 is inserted into each of the fixing protrusions 2112.

A plurality of supporting protrusions 2114 are provided with regular intervals so as to support both ends of the cap spring 220, and a support groove 2115, in which one end of the cap spring 220 is hung, is formed in the end of the supporting protrusions 2114.

Guide protrusions 2116 are formed between the plurality of supporting protrusions 2114 and guide smooth insertion when one end of the cap spring 220 is inserted into the fixing groove 2113.

The guide protrusions 2116 are adjacent to the insertion groove 2111.

A detachment groove 2117 that allows entrance and exit of a tool when the cap spring 220 is detached from the body 210, may be formed in the guide protrusions 2116.

Of course, the detachment groove 2117 may be omitted depending on the shape of the tool and a detachment method.

A hooking space 2118 is formed in the connection part 2110 and is provided in a direction in which the center of the body 210 crosses the insertion groove 2111, in a downward direction of the insertion groove 2111, and one end of the cap spring 220 is inserted in the hooking space 2118.

A hanging groove 2119 in which one end of the cap spring 220 is hung is formed in the hooking space 2118.

The hanging groove 2119 is formed to be recessed in one side of an upper inner side of the hooking space 2118 to a predetermined depth.

An accommodation space 2122 that is recessed to a predetermined depth so as to improve an adhesive force, is formed in the attachable portion 2120.

The accommodation space 2122 is divided into a center part 2124 formed in the center of the accommodation space 2122 and peripheral parts 2126 formed on the periphery of the center part 2124.

The accommodation space 2122 may be divided into three parts, i.e., the center part 2124 and the peripheral parts 2126 formed at both sides of the center part 2124 based on the body 210 attached to the teeth.

Furthermore, the center part 2124 and the peripheral parts 2126 have different recess depths.

In this case, the recess depth of each of the peripheral parts 2126 is larger than the recess depth of the center part 2124.

The reason why the center part 2124 and the peripheral parts 2126 have different recess depths, as described above, is that the accommodation amount of an adhesive applied to the peripheral parts 2126 is larger than that of the adhesive applied to the center part 2124 so that the adhesion strength of the body 210 in the peripheral parts 2126 is higher than in the center part 2124.

Also, a plurality of protrusions 2128 that protrude from the accommodation space 2122 so as to have the same surface as the surface of the attachable portion 2120 may be formed in the accommodation space 2122. The height of the plurality of protrusions 2128 is not limited thereto, and the plurality of protrusions 2128 may be higher than the center part 2124.

The cap spring 220 is a unit that is ligated to the body 210 and fixes the archwire 20 inserted into the insertion groove 2111 of the body 210.

The cap spring 220 includes an elastic fixing part 222 that is formed at one end of the cap spring 220 and is hung in and fixed to the fixing groove 2113 of the body 210, an elastic hanging part 224 that is formed at the other end of the cap spring 220 and is inserted in the hooking space 2118 of the body 210, and a connector 226 that connects the elastic fixing part 222 and the elastic hanging part 224.

The cap spring 220 may be formed of a material having an elastic force and a corresponding shape thereto.

In this case, the material of the cap spring 220 may be formed of a synthetic resin or metal, and the shape of the cap spring 220 may be an overall ‘C’-shape and more preferably, may perform the function of an elastic body.

A bent portion 223 that is bent to an outer side of the elastic fixing part 222 at a predetermined angle so that a force applied to the bent portion 223 against the fixing groove 2113 can be amplified, is formed on the elastic fixing part 222. The bent portion 223 has a bent shape that is the same as or similar to the supporting protrusions 2114 and the support groove 2115 of the body 210.

A tool insertion hole 228 is formed in one side of the elastic fixing part 222 or the connector 226, allows part of a tool used when the cap spring 220 is detached from the body 210 to be inserted into the tool insertion hole 228 and allows the cap spring 220 to be easily detached from the body 210.

A hanging protrusion 225 that is hung in the hanging groove 2119 formed in the hooking space 2118 of the body 210, is formed at one side of the elastic hanging part 224.

In this case, since the length of the elastic hanging part 224 is larger than the length of the elastic fixing part 222, when the cap spring 220 is coupled to the body 210, first, the elastic hanging part 224 is inserted in the hooking space 2118 of the body 210 so that stable ligation of the cap spring 220 can be performed.

That is, the cap spring 220 is configured in such a way that the elastic fixing part 222 having the bent portion 223 formed at an end of the elastic fixing part 222 is formed while the cap spring 220 is divided into both sides so that both sides can be supported by both-end supporting protrusions 2114 of the body 210, the tool insertion groove 228 is formed in the center of the cap spring 220 that is connected from the elastic fixing part 222 to the connector 226 so that the cap spring 220 can be ‘C’-shaped, and the elastic hanging part 224 is formed so that the hanging protrusion 225 protrudes from the end of the connector 226 and the elastic hanging part 224 has a size at which the elastic hanging part 224 can be inserted in the hooking space 2118.

An operating state of the self-ligation orthodontic bracket having the above configuration according to the first embodiment of the present invention will now be described as follows.

As illustrated in FIG. 5, in a state in which the body 210 is attached to the surface of the teeth, an adhesive is applied to the attachable portion 2120 of the body 210, i.e., the accommodation space 2122.

In this case, the adhesive is applied in such a way that a larger amount of the adhesive than the adhesive applied to the center part 2124 is applied to the peripheral parts 2126.

The body 210 is attached to and fixed to the surface of the teeth as a procedure target.

Subsequently, the archwire 20 is inserted into the insertion groove 2111 of the body 210 so as to correct irregularities, and the cap spring 220 is ligated to the body 210 so as to fix the archwire 20.

A state in which the cap spring 220 is coupled to the body 210 will now be described as below.

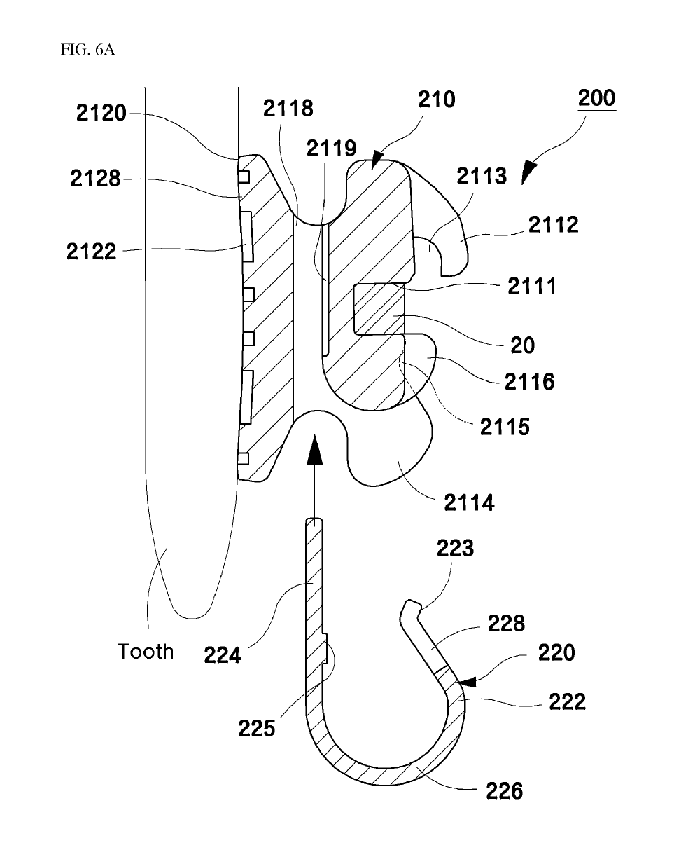

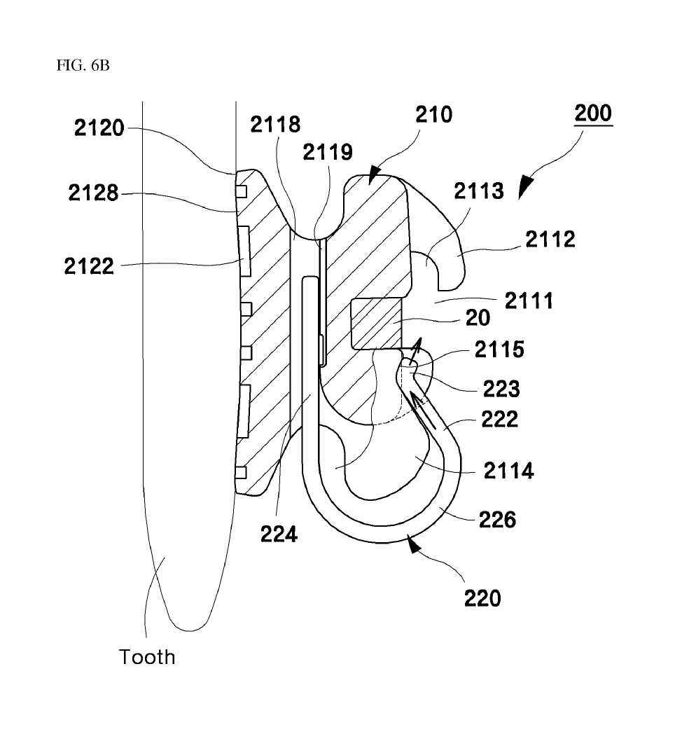

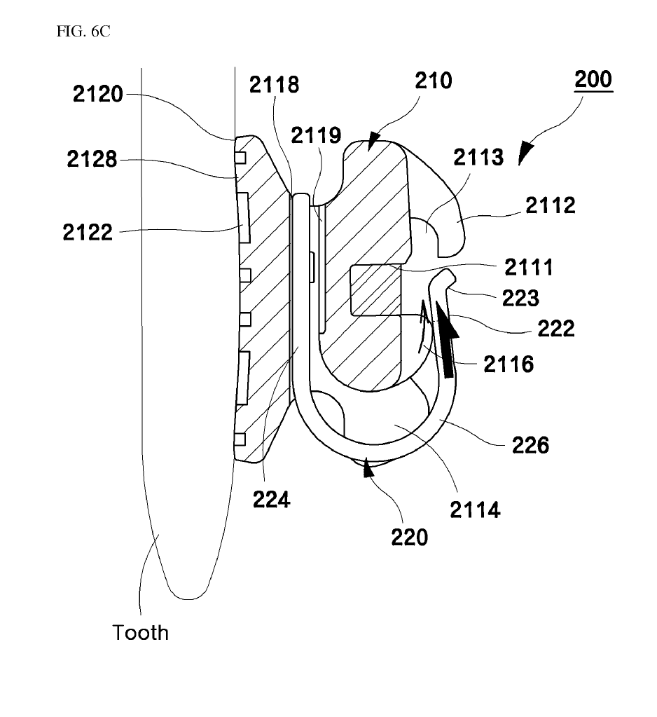

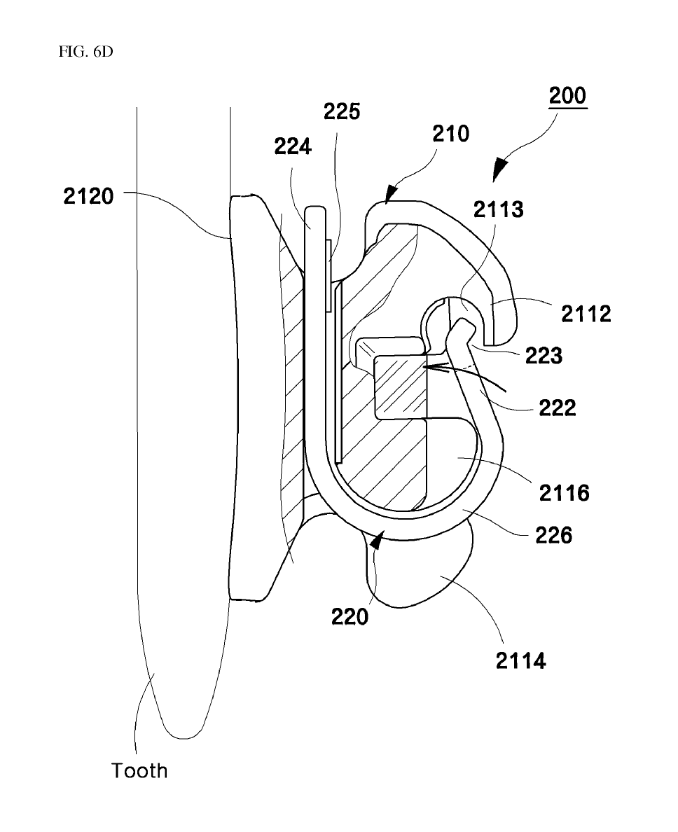

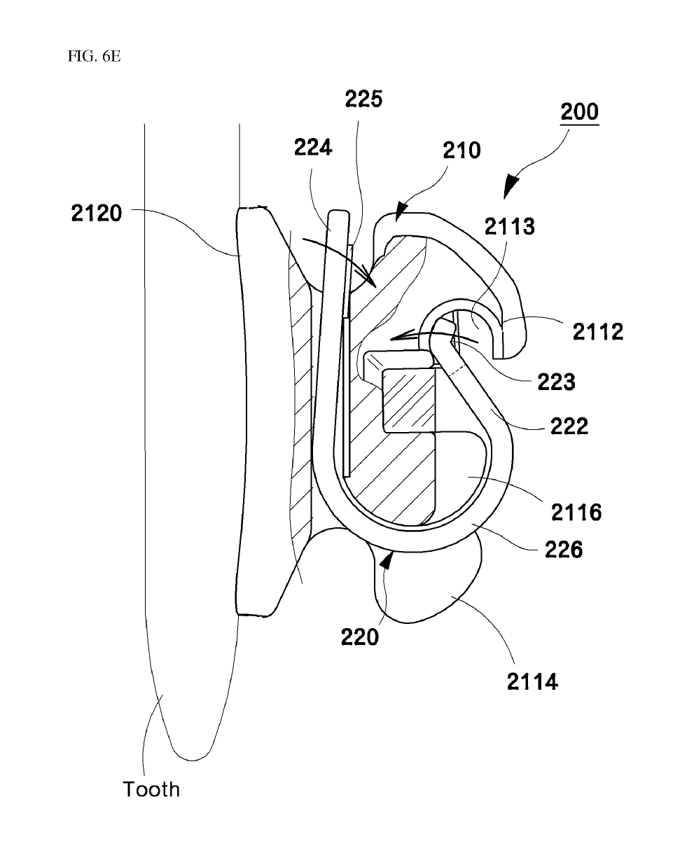

FIG. 6A illustrates a state before the cap spring 220 is ligated to the body 210. In this case, the body 210 is attached to the surface of the teeth, as described above.

FIG. 6B illustrates a state in which the cap spring 220 is first ligated to the body 210 attached to the surface of the teeth. The elastic hanging part 224 of the cap spring 220 is inserted in the hooking space 2118 of the body 210, and the elastic fixing part 222 of the cap spring 220 is first hung in the supporting protrusions 2114 and the support groove 2115 of the body 210.

That is, the support groove 2115 and the bent portion 223 of the elastic fixing part 222 have the same or similar shapes and thus they are stably mounted on the supporting protrusions 2114, and the hanging protrusion 225 of the elastic hanging part 224 of the cap spring 220 is hung in the hanging groove 2119 of the hooking space 2118, and as such, first ligation of the cap spring 220 to the body 210 is performed.

In this case, since both ends of the elastic fixing part 222 of the cap spring 220 are mounted on both-end supporting protrusions 2114 of the body 210, the elastic fixing part 222 is not interfered by the guide protrusions 2116 provided between the supporting protrusions 2114.

Of course, since a space between the elastic fixing part 222 and the elastic hanging part 224 of the cap spring 220 is in a compressed state in which a space between the supporting protrusion 2114 and the hooking space 2118 are tightened, due to an elastic action, the cap spring 220 is not randomly detached from the body 210.

Meanwhile, as described above, an operation of attaching the body 210 to the surface of the teeth in a state in which the cap spring 220 is first ligated to the body 210 or an operation of inserting the archwire 20 into the body 210 to which the cap spring 220 is first ligated may be performed.

FIG. 6C illustrates an operation of pushing the first-ligated cap spring 220 into the body 210.

If the first-ligated cap spring 220 is further pushed into the body 210, the bent portion 223 of the elastic fixing part 222 of the cap spring 220 climbs over the support groove 2115 of the supporting protrusions 2114, and the connector 226 positioned in the rear of the elastic fixing part 222 is positioned on top surfaces of the guide protrusions 2116 provided between the supporting protrusions 2114.

Furthermore, the guide protrusions 2116 are positioned higher than the supporting protrusions 2114, as illustrated in FIG. 6C, and thus widen a distance between the elastic fixing part 222 and the elastic hanging part 224 of the cap spring 220.

In this case, a maximum widening force is applied to the elastic fixing part 222 by the guide protrusions 2116, and due to this action, the elastic hanging part 224 that is elastically connected to the elastic fixing part 222 is temporarily widened so that hanging regulation of the hanging protrusion 225 of the elastic hanging part 224 hung in the hanging groove 2119 of the hooking space 2118 of the boy 210 is temporarily released.

This action is useful in detaching the cap spring 220 from the body 210. If the hanging protrusion 225 is ligated to or detached from the body 210 and the hanging protrusion 225 is still hung in the hanging groove 2119, a ligation or detachment operation is interfered by the hung state and thus may not be easily performed, and the problem that the hanging protrusion 225 may be damaged and its function may be lost, may occur depending on an occasion.

FIG. 6D illustrates a state in which insertion of the cap spring 220 into the body 210 is completed.

That is, the cap spring 220 is pushed into the body 210 until outer circumferential surfaces of the guide protrusions 2116 of the body 210 and an inner circumferential surface of the connector 226 of the cap spring 220 are closely adhered to each other.

In this case, the elastic fixing part 222 that is widened to the maximum by the guide protrusions 2116 is narrowed due to an elastic restoring force, and the bent portion 223 is inserted into the fixing groove 2113 formed in the fixing protrusions 2112.

In this case, the connector 226 of the cap spring 220 that is closely adhered to the body 210 is ‘C’-shaped and thus is not widened by the guide protrusions 2116.

FIG. 6E illustrates a state in which the cap spring 220 is finally ligated to the body 210.

The elastic fixing part 222 and the elastic hanging part 224 of the cap spring 220 that is fully closely adhered to the body 210 are narrowed due to the elastic restoring force, as illustrated in FIG. 6E.

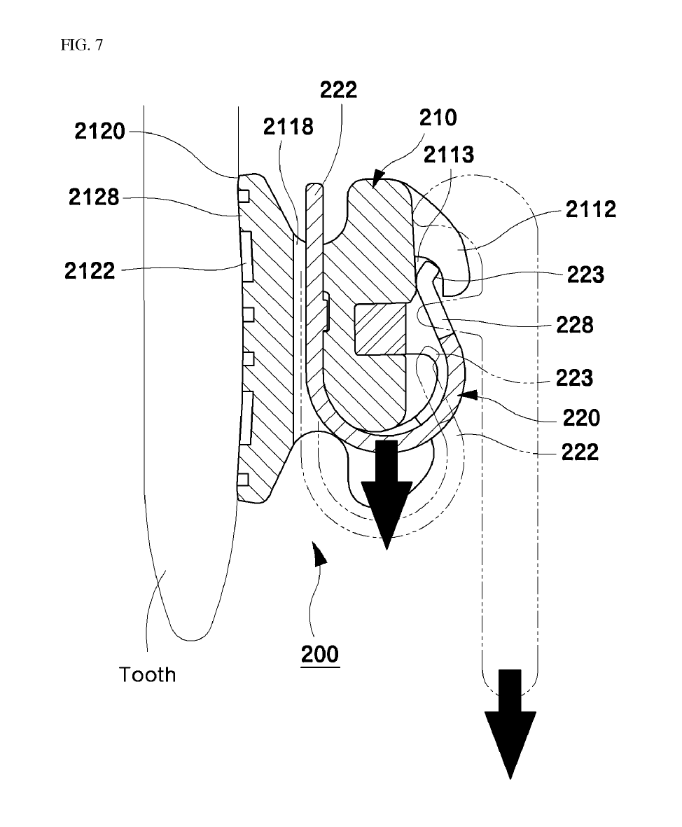

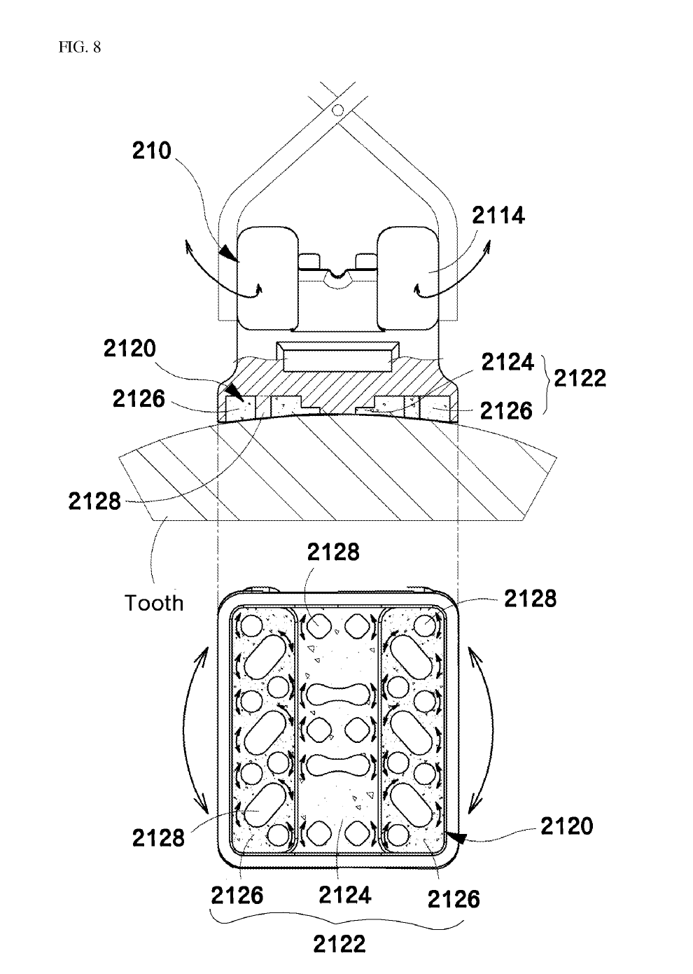

FIG. 7 is a view illustrating a state in which the cap spring 220 is detached from the body 210, according to an embodiment of the present invention, and FIG. 8 is a view illustrating a state in which the body 210 is detached from the teeth, according to an embodiment of the present invention. A state in which the bracket is detached from the teeth will now be described with reference to the above drawings.

First, when the cap spring 220 is detached from the body 210, part of the tool is inserted into the tool insertion groove 228 of the cap spring 220 and then is pulled in a detachment direction, the elastic fixing part 222 and the elastic hanging part 224 of the cap spring 220 are forcibly detached from the fixing groove 2113 and the hooking space 2118 of the body 210 due to the pulling force so that the cap spring 220 can be separated from the body 210.

Then, the archwire 20 is removed from the insertion groove 2111 of the body 210 from which the cap spring 220 is separated.

Referring to FIG. 8, both sides of the body 210 fixed to the teeth are shaken in a state in which one end of the body 210 is grasped using a tool such as a flier.

In this case, both sides of the body 210 that are bitten by the tool are more shaken, and a center of the body 210 is relatively less shaken.

Thus, the peripheral parts 2126 of the attachable portion 2120 are first detached from the teeth.

Also, the center part 2124 having a relatively smaller applied amount of the adhesive than the peripheral parts 2126 may be detached from the teeth even when it is relatively less shaken than force applied to shake the peripheral parts 2126.

That is, an attachment surface is a flat surface according to the related art and thus the attachable portion has the same adhesion strength in its positions. When the body is removed from the teeth, even though both ends of the body are first detached from the teeth, the body is still maintained while its center is attached to the teeth. Thus, more force should be applied during a removal operation so as to detach the body from the teeth.

In this case, the center of the body is detached from the teeth, and simultaneously, an enamel layer of the teeth is together detached so that a secondary problem that may cause an injury of the teeth occurs.

Meanwhile, since a plurality of protrusions 118 having the same surfaces as the surface of the attachment surface 110 are formed in the accommodation space 112, i.e., on the center part 114 and the peripheral parts 116, no adhesive is applied to the protrusions 118, or even when the adhesive is applied to the protrusions 118, an adhesive force is minute. Thus, when the body 210 is removed from the teeth, as illustrated in FIG. 8, force that causes the body 210 to be shaken by the tool is applied to the periphery of the protrusions 2128 in the same manner so that the body 210 can be easily detached from the teeth with a small force.

### Second Embodiment

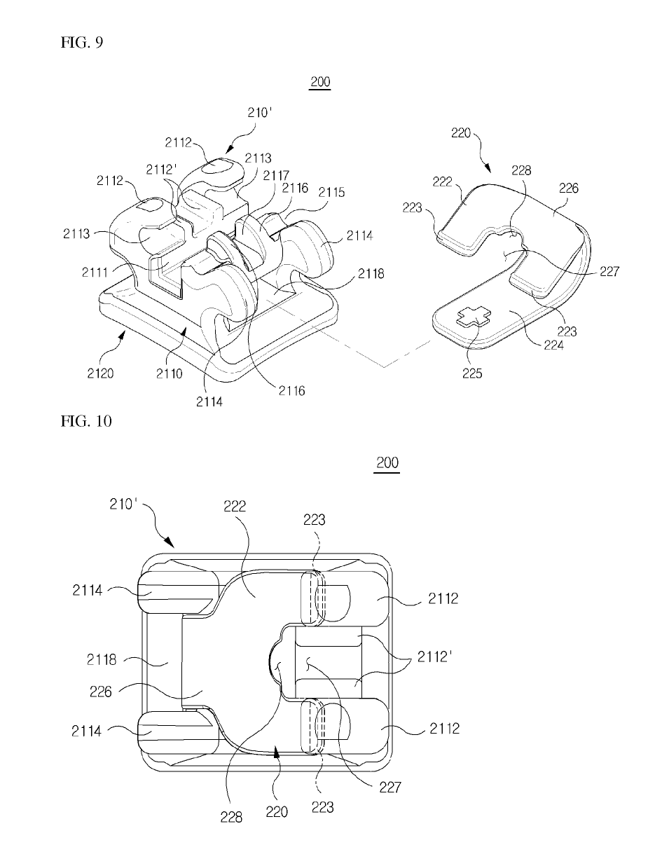

FIG. 9 is an exploded perspective view of a bracket according to another embodiment of the present invention, and FIG. 10 is a plan view illustrating a state in which a cap spring 220 is coupled to a body 210′, according to another embodiment of the present invention.

The second embodiment of the present invention is different from the first embodiment in that fixing protrusions 2112 and hanging protrusion parts 2112′ of the body 210′ are formed. Other elements than the fixing protrusions 2112 and the hanging protrusion parts 2112′ of the body 210′ are the same as those of the first embodiment described with reference to FIGS. 3 through 8.

Hereinafter, like reference numerals are used for like elements as those of the first embodiment, and detailed descriptions thereof will be omitted.

The body 210′ includes the hanging protrusion parts 2112′ that protrude between the fixing protrusions 2112 and are formed close to the fixing protrusions 2112 so that the center of the body 210′ passes through the hanging protrusion parts 2112′.

The hanging protrusion parts 2112′ of the body 210′ closely support both ends of a fitting groove 227 of a cap spring 220 so that the cap spring 220 can be prevented from moving in right and left directions.

The hanging protrusion parts 2112′ of the body 210′ have a hanging structure in which both ends of the fitting groove 227 of the cap spring 220 are hung in the hanging protrusion parts 2112′ and are fixed thereto.

The cap spring 220 is a unit that is ligated to the body 210′ and fixes an archwire 20 inserted into an insertion groove 2111 of the body 210′.

The cap spring 220 includes an elastic fixing part 222 that is formed at one end of the cap spring 220 and is hung in and fixed to a fixing groove 2115 of the body 210′, an elastic hanging part 224 that is formed at the other end of the cap spring 220 and is inserted in a hooking space 2118 of the body 210′, the fitting groove 227, of which both ends are fitted to and fixed to the hanging protrusion parts 2112′, and a connector 226 that connects the elastic fixing part 222 and the elastic hanging part 224.

Since both ends of the fitting groove 227 formed in the elastic fixing part 222 are hung in, fitted to, and fixed to the hanging protrusion parts 2112′ of the body 210′, the cap spring 220 is prevented from moving in right and left directions and is firmly fixed.

An operating state of a self-ligation orthodontic bracket having the above configuration according to the second embodiment of the present invention will now be described as below.

A bent portion 223 of the cap spring 220 is inserted into and fixed to the fixing groove 2113 of the body 210′ and simultaneously, both ends of the fitting groove 227 formed in the elastic fixing part 222 of the cap spring 220 are hung in and fitted to the hanging protrusion parts 2112′ of the body 210′.

In this case, since the fitting groove 227 of the cap spring 220 is fitted to and fixed to the hanging protrusion parts 2112′ of the body 210′, a fixing force of the cap spring 220 is strong, and the cap spring 220 is prevented from moving in right and left directions.

While the invention has been shown and described with reference to certain exemplary embodiments thereof, it will be understood by those skilled in the art that various changes in form and details may be made therein without departing from the spirit and scope of the invention as defined by the appended claims.

As described above, as a bracket including a body and a cap spring is provided, the number of components is minimized, manufacturing cost is reduced, the number of working processes is reduced so that the whole product price can be lowered, and a phenomenon that food gets stuck is minimized so that an injury of the teeth and discoloration of the bracket can be prevented and product competitiveness can be strengthened.

1. A self-ligation orthodontic bracket comprising:
a body comprising a connection part that is formed at one side of the body and allows an archwire to be inserted and to be supported and an attachable portion that is formed at the other side of the body and is adhered to teeth, wherein the connection part comprises an insertion groove formed in a horizontal direction based on an installation state of the bracket and having a predetermined depth at which the archwire is inserted into the insertion groove, a plurality of fixing protrusions formed at an upper part of the insertion groove and having a fixing groove formed in one side of each of the plurality of fixing protrusions, a plurality of supporting protrusions formed at a lower part of the insertion groove and spaced apart from each other by a predetermined distance, guide protrusions formed between the plurality of supporting protrusions and protruding to a predetermined height, and a hooking space that is formed in a downward direction of the insertion groove and is penetrated in a direction in which a center of the body crosses the insertion groove; and
a cap spring comprising an elastic fixing part that is formed at one side of the cap spring and an elastic hanging part that is formed at the other side of the cap spring, wherein a bent portion is formed at an end of the elastic fixing part and is bent to an outer side of the elastic fixing part at a predetermined angle, when both ends of the elastic fixing part are supported and enter between the supporting protrusions of the body, the elastic fixing part is guided to outer surfaces of the guide protrusions, the bent portion of the elastic fixing part is inserted into the fixing groove, and the elastic hanging part is inserted into the hooking space of the body and is ligated to the body.

2. The self-ligation orthodontic bracket of claim 1, wherein the body further comprises a hanging groove formed in one side of the hooking space and having a predetermined depth, and
the cap spring further comprises a hanging protrusion formed at one side of the elastic hanging part and having a predetermined height at which the hanging protrusion is inserted into the hanging groove of the body when the elastic hanging part is ligated to the body.

3. The self-ligation orthodontic bracket of claim 1, wherein a tool insertion hole is formed in one side of the elastic fixing part of the cap spring and allows part of a tool used when the cap spring is detached from the body to be inserted into the tool insertion hole and allows the cap spring to be easily detached from the body.

4. The self-ligation orthodontic bracket of claim 1, wherein an accommodation space that is recessed to a predetermined depth so that a predetermined amount of an adhesive is accommodated in the accommodation space when the adhesive is applied to the attachable portion, is formed in the attachable portion of the body,
a center part is formed in the accommodation space, and
peripheral parts having a larger depth than the center part are formed on a periphery of the center part.

5. The self-ligation orthodontic bracket of claim 4, wherein a plurality of protrusions are formed in the accommodation space, and as the plurality of protrusions have heights that are the same as or slightly less than a surface of the attachable portion and no adhesive accommodated in the accommodation space is applied to the attachable portion, the plurality of protrusions allow the body to be easily detached from the teeth as air permeates into portions where no adhesive is applied, when a tool is shaken so as to remove the body from the teeth after an orthodontic operation is completed.

6. The self-ligation orthodontic bracket of claim 4, wherein the accommodation space is divided into three parts, that is, a center part and peripheral parts formed at both sides of the center part based on the body adhered to the teeth.

7. A self-ligation orthodontic bracket comprising:
a body comprising a connection part that is formed at one side of the body and allows an archwire to be inserted and to be supported and an attachable portion that is formed at the other side of the body and is adhered to teeth, wherein the connection part comprises an insertion groove formed in a horizontal direction based on an installation state of the bracket and having a predetermined depth at which the archwire is inserted into the insertion groove, a plurality of fixing protrusions formed at an upper part of the insertion groove and having a fixing groove formed in one side of each of the plurality of fixing protrusions, hanging protrusion parts that protrude between the plurality of fixing protrusions and are formed close to the fixing protrusions so that the center of the body passes through the hanging protrusion parts, a plurality of supporting protrusions formed at a lower part of the insertion groove and spaced apart from each other by a predetermined distance, guide protrusions formed between the plurality of supporting protrusions and protruding to a predetermined height, and a hooking space that is formed in a downward direction of the insertion groove and is penetrated in a direction in which a center of the body crosses the insertion groove; and
a cap spring comprising an elastic fixing part that is formed at one side of the cap spring and an elastic hanging part that is formed at the other side of the cap spring, wherein a bent portion is formed at an end of the elastic fixing part and is bent to an outer side of the elastic fixing part at a predetermined angle, a fitting groove is formed through one side of the elastic fixing part, when both ends of the elastic fixing part are supported and enter between the supporting protrusions of the body, the elastic fixing part is guided to outer surfaces of the guide protrusions, the bent portion of the elastic fixing part is inserted into the fixing groove, the elastic hanging part is inserted into the hooking space of the body and is ligated to the body, and both ends of the fitting groove are fitted to and fixed to the hanging protrusion parts.

8. The self-ligation orthodontic bracket of claim 7, wherein the body further comprises a hanging groove formed in one side of the hooking space and having a predetermined depth, and
the cap spring further comprises a hanging protrusion formed at one side of the elastic hanging part and having a predetermined height at which the hanging protrusion is inserted into the hanging groove of the body when the elastic hanging part is ligated to the body.

9. The self-ligation orthodontic bracket of claim 7, wherein a tool insertion hole is formed in a side of the fitting groove of the cap spring and allows part of a tool used when the cap spring is detached from the body to be inserted into the tool insertion hole and allows the cap spring to be easily detached from the body.

10. The self-ligation orthodontic bracket of claim 7, wherein an accommodation space that is recessed to a predetermined depth so that a predetermined amount of an adhesive is accommodated in the accommodation space when the adhesive is applied to the attachable portion, is formed in the attachable portion of the body,
a center part is formed in the accommodation space, and
peripheral parts having a larger depth than the center part are formed on a periphery of the center part.

11. The self-ligation orthodontic bracket of claim 10, wherein a plurality of protrusions are formed in the accommodation space, and as the plurality of protrusions have heights that are the same as or slightly less than a surface of the attachable portion and no adhesive accommodated in the accommodation space is applied to the attachable portion, the plurality of protrusions allow the body to be easily detached from the teeth as air permeates into portions where no adhesive is applied, when a tool is shaken so as to remove the body from the teeth after an orthodontic operation is completed.

12. The self-ligation orthodontic bracket of claim 10, wherein the accommodation space is divided into three parts, that is, a center part and peripheral parts formed at both sides of the center part based on the body adhered to the teeth.

13. The self-ligation orthodontic bracket of claim 2, wherein an accommodation space that is recessed to a predetermined depth so that a predetermined amount of an adhesive is accommodated in the accommodation space when the adhesive is applied to the attachable portion, is formed in the attachable portion of the body,
a center part is formed in the accommodation space, and
peripheral parts having a larger depth than the center part are formed on a periphery of the center part.

14. The self-ligation orthodontic bracket of claim 3, wherein an accommodation space that is recessed to a predetermined depth so that a predetermined amount of an adhesive is accommodated in the accommodation space when the adhesive is applied to the attachable portion, is formed in the attachable portion of the body,
a center part is formed in the accommodation space, and
peripheral parts having a larger depth than the center part are formed on a periphery of the center part.

15. The self-ligation orthodontic bracket of claim 8, wherein an accommodation space that is recessed to a predetermined depth so that a predetermined amount of an adhesive is accommodated in the accommodation space when the adhesive is applied to the attachable portion, is formed in the attachable portion of the body,
a center part is formed in the accommodation space, and
peripheral parts having a larger depth than the center part are formed on a periphery of the center part.

16. The self-ligation orthodontic bracket of claim 9, wherein an accommodation space that is recessed to a predetermined depth so that a predetermined amount of an adhesive is accommodated in the accommodation space when the adhesive is applied to the attachable portion, is formed in the attachable portion of the body,
a center part is formed in the accommodation space, and
peripheral parts having a larger depth than the center part are formed on a periphery of the center part.
